(19) United States
(12) Patent Application Publication
(10) Pub. No.: US 2016/0328753 A1
(43) Pub. Date: Nov. 10, 2016

(54) Video Messages and Methods for their Creation

(71) Applicant: The Procter & Gamble Company, Cincinnati, OH (US)

(72) Inventors: Theresa Muench, Cincinnati, OH (US); Andrea Nolting, Cincinnati, OH (US); Sundar G. Raman, Cincinnati, OH (US)

(21) Appl. No.: 14/706,055

(22) Filed: May 7, 2015

(51) Int. Cl. G06Q 30/02

(52) U.S. Cl. CPC G06Q 30/0276

(57) ABSTRACT

A method for structuring the content of an advertisement for a product or service includes: providing a first message element associated with a primary product or service, providing a second message element associated with a different product or service. The first message element includes message-copy and a message-copy-timeline. The second message element is inserted into the first message element message-copy-timeline contemporaneously with the expression of a portion of the first message element message-copy relevant to the second message element. The combination of elements is presented.

### FIELD OF THE INVENTION

The invention relates to methods for the structuring of information for presentation. The invention relates particularly to the arrangement of information within a video presentation to be utilized as an advertisement.

### BACKGROUND OF THE INVENTION

Advertising products and services represents a significant challenge to the manufacturers and marketers. Capturing the attention of a target audience, holding that attention long enough to convey a message, and successfully driving a desired behavior with that message requires innovative ways of structuring the content of the message. This is particularly so in a world where the number of sources competing for the momentary attention of the target audience continues to grow, and the ease with which the audience may shift from one source to another increases. It is also of increased significance as the complexity of the product landscape increases bringing with that increase a desire by marketers to share more complex stories, including stories bridged across multiple products having a relationship to each other. What is needed is a manner for combining multiple dimensions of the story associated with multiple products and/or services such that more than a single aspect of the story may be conveyed in a single message when that message is presented to the audience.

### SUMMARY OF THE INVENTION

In one aspect, a method for structuring the content of an advertisement for a product or service, includes: providing a first message element associated with a primary product or service, providing a second message element; inserting the second message element into the first message element; and presenting the combined first and second message elements. The first message element includes message-copy and a message-copy-timeline;

The second message element is inserted into the first message element message-copy-timeline contemporaneously with the expression of a portion of the first message element message-copy relevant to the second message element.

In one aspect the invention includes the video presentation file structured according to the method. The video file may be of any video file format stored using a non-transitory electronic-file storage medium.

### DETAILED DESCRIPTION OF THE INVENTION

As used herein, the term advertisement refers to a collection of auditory and visual elements combined for the purpose of advertising a product or service, intended for presentation via the internet, television or other video viewing means including via placement upon storage media for presentation in association with other content of the storage media e.g. as a commercial advertisement prior to the presentation of a motion picture stored upon a DVD or other media element. The visual elements may include video and static images as well as static and moving text within the framework of the overall video.

As used herein the terms message-copy means all content of a message including, for a video message, the sound track as well as the video track including all visual elements depicted as part of the video track.

As used herein, the terms message-copy timeline, means a depiction of the elements of the message copy arrayed along a path analogous to the progression of time during the presentation of the message-copy of the advertisement.

As used herein, the term message element means a portion of the message copy having, or representing stand-alone meaning. Message elements may be combined into compound message elements, also referred to herein using the broader term message element. Exemplary message elements include: words, phrases, individual visual elements and combinations of visual elements, as well as audible and visual elements in combination with each other.

As used herein the term message track means the theme, or summary, of the overall message which the advertiser seeks to convey using the message-copy.

In one aspect, the method for structuring the content of an advertisement for a product or service comprises steps of: providing a first advertisement associated with a primary product or service, providing a second advertisement comprising a message track; inserting the secondary advertisement into the first advertisement; and presenting the combined first and second advertisement.

The output, deliverable, or product of the use of the method includes: a video advertisement, the advertisement comprising: a first advertisement associated with a primary product or service, and comprising a message copy and a message copy timeline; a second advertisement comprising a message track, the secondary advertisement disposed within the first advertisement.

The second advertisement is disposed within the first advertisement message copy timeline as or after the expression of a portion of the first advertisement message copy relevant to the second advertisement message track.

The first advertisement comprises message copy and a message-copy timeline. The message-copy may be considered as a series of message elements disposed along the message-copy timeline. Individual message elements and combinations of message elements may have particular meanings. The timeline may be considered as a means for depicting the respective time associated with each member of a set of message elements or with each element of a set of meanings.

The second advertisement may be considered as a set of meanings as well, this set may be further summarized as a message track. The message track of the second advertisement may be use to identify a particular location along the message-copy timeline of the first advertisement where the insertion of the second advertisement may most significant beneficial impact upon the viewer of the combined advertisements.

The identification of the insertion point may take advantage of the relative meanings of the message track of the second advertisement together with the set of meanings of the respective message elements of the first advertisement along the message-copy timeline.

The relative meanings may be overt or subtle

The second advertisement may be inserted contemporaneous with an actual mention of the second product in conjunction with the first product.

An advertisement associated with a product which provides a consumer benefit of enhanced scent experiences, may be inserted contemporaneous with the mention of the delightful smell associated with the use of a first product.

Specific information associated with a sponsored event may be inserted contemporaneous with a mention of sponsorship of the event by the primary product.

Exemplary considerations for the placement of the visual elements of the second advertisement include: inserting so as to augment the visual elements of the primary advertisement, to maximize the visual impact of the secondary inserted elements, to avoid conflicting with the progression of visuals of the primary advertisements.

The message track of the secondary advertisement may include an offer associated with the secondary product or service. The message track may comprise information regarding a product or service use regiment incorporating each of the primary and secondary products or services. The message track may be associated with the respective benefits of the secondary product or service as part of a portfolio regimen presented contemporaneously with message-copy associated with the benefits associated with the use of the primary product or service as part of that regimen.

In one aspect, the method may be used to enhance the drama associated with the copy of the first advertisement, or to reinforce a product claim made in the advertising copy. In this embodiment, the second advertisement message track may relate to the original product by way of the product claim made in the first message track.

In one embodiment of the method, message elements of the first advertisement may each be assigned a value according o the message track for the respective elements; the message track for the second advertisement may also be assigned a value. A comparison of the values for the message elements of the first advertisement and the second advertisement may be used to provide an indication of the appropriateness of inserting the second advertisement at any particular point along the timeline of the first advertisement. As an example, among the values assigned to elements of the first advertisement, scent, may be assigned to a portion of the advertisement where the benefit of a fresh scent is associated with the use of the first product or service. The message track of the second product may have a value of scent as well. The combination of values may be used to determine the point during the first advertisement where the insertion of the second advertisement would be effective by making the insertion such that the second advertisement is provided contemporaneously with the portion of the first advertisement having the same value.

The message track may comprise a performance claim associated with the primary product and inserted contemporaneously with primary message-copy associated with the performance claim. The video presentations of the invention may be created using the steps of the method and appropriate video editing software such as Final Cut Pro®, available from Apple, Cupertino, Calif., Avid ProTools®, available from Avid Technology, Inc., Burlington, Mass., and other known video creation and editing software products.

### EXAMPLES

In a first scene of a video advertisement, as a father mentions the use of TIDE® laundry detergent for removing week old stains, an image of a package of TIDE® appears superimposed upon the background scene, in a subsequent portion of the advertisement along the message copy timeline, as the father mentions the additional use of DOWNY® fabric softener to make the clothes fresh and soft, an image of a package of DOWNY® appears in addition to the image of the package of TIDE®. In this example, the message track of the first advertisement explicitly calls out the use of the second product as the imagery associated with that product appears in the video.

In a first scene of an advertisement, a voice-over states that using GAIN® FLINGS®, is like music to your nose, at the mention of the scent benefit of the primary product, a green background field is inserted into the main image of the video and an image of a package of GAIN® FIREWORKS® scent booster, and the text: For even more freshness add: appear superimposed upon the new background field within the primary advertising video. In this example, the message track of the first advertisement makes reference to the scent benefits of the primary product presenting an opportunity to introduce the second product, also associated with the scent benefit, into the video content stream.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for structuring the content of an advertisement for a product or service, the method comprising steps of:
providing a first advertisement associated with a primary product or service, and comprising message copy and a message copy timeline;
providing a second advertisement comprising a message track;
inserting the secondary advertisement into the first advertisement;
presenting the combined first and second advertisement;
wherein the second advertisement is inserted into the first advertisement message copy timeline as or after the expression of a portion of the first advertisement message copy relevant to the second advertisement message track.

2. The method according to claim 1 wherein the visual elements of the secondary advertisement are disposed within the visual framing of the primary advertisement according to an association between the placement location, the visual elements of the primary advertisement and the portion of the message copy of the first advertisement.

3. The method according to claim 1 wherein the message track comprises an offer associated with the primary product or service.

4. The method according to claim wherein the message track comprises a product or service use regimen associated with the primary product or service and a secondary product or service.

5. The method according to claim 1 wherein the message track comprises a portfolio regimen associated with a benefit of the primary product or service and a secondary product or service selected from a portfolio of products or services associated with the benefit.

6. The method according to claim 1 wherein the message track comprises a performance claim associated with the primary product or service.

7. The method according to claim 1 wherein the message track comprises information relating to an event or activity associated with, or sponsored by the primary product or service.

8. A video advertisement, the advertisement comprising:
a) a first advertisement associated with a primary product or service, and comprising a message copy and a message copy timeline;
b) a second advertisement comprising a message track, the secondary advertisement disposed within the first advertisement;
wherein the second advertisement is disposed within the first advertisement message copy timeline as or after the expression of a portion of the first advertisement message copy relevant to the second advertisement message track.

9. The advertisement according to claim 8 wherein the visual elements of the secondary advertisement are disposed within the visual framing of the primary advertisement according to an association between the placement location, the visual elements of the primary advertisement and the portion of the message copy of the first advertisement.

10. The advertisement according to claim 8 wherein the message track comprises an offer associated with the primary product or service.

11. The advertisement according to claim 8 wherein the message track comprises a product or service use regimen associated with the primary product or service and a secondary product or service.

12. The advertisement according to claim 8 wherein the message track comprises a portfolio regimen associated with a benefit of the primary product or service and a secondary product or service selected from a portfolio of products or services associated with the benefit.

13. The advertisement according to claim 8 wherein the message track comprises a performance claim associated with the primary product or service.

14. The advertisement according to claim 8 wherein the message track comprises information relating to an event or activity associated with, or sponsored by the primary product or service.
